(19) United States
(12) Patent Application Publication
(10) Pub. No.: US 2022/0362997 A1
(43) Pub. Date: Nov. 17, 2022

(54) PRINTING TABLE AND OPERATION MODE THEREOF

(71) Applicant: TOBB EKONOMI VE TEKNOLOJI UNIVERSITESI, Ankara (TR)

(72) Inventors: Gokberk SERIN, Ankara (TR); Recep Muhammet GORGULUARSLAN, Ankara (TR); Batihan SENER, Ankara (TR); Hakki Ozgur UNVER, Ankara (TR)

(21) Appl. No.: 17/621,171

(22) PCT Filed: Jun. 17, 2020
(86) PCT No.: PCT/TR2020/050518

§ 371 Date: Dec. 20, 2021

(30) Foreign Application Priority Data
Jun. 25, 2019 (TR) 2019/09399

(51) Int. Cl. B29C 64/241; B29C 64/245

(52) U.S. Cl. CPC B29C 64/241; B29C 64/245

(57) ABSTRACT

A printing table which is used in printers adapted to form a three-dimensional solid model and which provides for positioning the solid model to be created during its production.

### TECHNICAL FIELD

The present invention relates to a printing table which is used in the printers adapted to form a three-dimensional solid model and provides positioning the solid model to be created during its production and to an operation method thereof.

### PRIOR ART

The three-dimensional printing is the process of printing a three-dimensional object with any shape in solid form which is designed in a virtual platform. The devices that carry out this process are called three-dimensional (3D) printers. 3D printers are generally used with thermoplastic polymer materials such as ABS and PLA. The material in filament form is constructed in layers by being melted with the help of a high temperature nozzle. First of all a 3D model is required in order to make production with the 3D printers. Some of the software to be used in this field is AutoCAD, SolidWorks, Google Sketchup, Rhino3D etc. The models designed with this software can be created with 3D printers by forming the same as STL files. The three-dimensional printers are in two types namely Cartesian type and delta type. The Cartesian type three-dimensional printers use Cartesian coordinate systems. The extruder (print head) and the table can perform linear movement on the horizontal and vertical axes in the Cartesian type three-dimensional printers. A decrease in the product quality can be seen particularly in the systems where the table only moves forward and backward on the horizontal and vertical axes.

The three-dimensional printers in the state of the art can make linear positioning only on horizontal and vertical axes (X, Y, Z). When the hanging surface angle in the solid model with different angular geometries that is preferred to be printed is higher than a certain angle (45 degrees) value, the three-dimensional printer requires support units to print these surfaces. The use of support units both increase the duration of production and affects the surface quality in a negative manner. For this reason, three-dimensional printers (3B) having the ability to move along 5-axis are developed in order to minimize the use of the support units during production. However, when the conventional planar slicing methods are used in said 5-axis three dimensional printers, they remain incapable of printing the parts with better surface quality by shortening production durations and using less support units. Therefore, in the three-dimensional (3D) printers that can move on 5-axis, when the planar slicing method that is used in the existing three-dimensional (3D) printers is used, successful results cannot be achieved in the production of complex geometries such as impeller part used in the pumps or motors with free-form surfaces. An adaptive planar slicing method has been developed to be used in 5-axis three-dimensional (3D) printers in order to eliminate this problem.

The inventive printing table and the operation method thereof are used in the printers adapted to create a three-dimensional solid model and enable positioning the solid model to be created during the production. The print head in the three-dimensional printer included in the present invention can be able to move on the horizontal axis, vertical axis and on the vertical axis linearly. The printing table can perform rotation movement around the horizontal axis and the vertical axis. There is a movable lower table on the printing table. The rotational movement of the lower table on the horizontal axis and the vertical axis is enabled by means of the horizontal rotation provider and the vertical rotation provider.

In the state of the art, there is no explanation regarding the technical features and the technical effects provided by the invention of the present application. There is no printing table in the current application that can be able to move in 5-axis, has an operation method that allows the lower table to rotate around the horizontal and vertical axis.

### AIMS OF THE INVENTION

The aim of this invention is to provide a printing table and an operation method thereof which is adapted to perform linear movement on the horizontal axis, perpendicular axis and the vertical axis and rotational movement about the horizontal axis and the vertical axis.

Another aim of the invention is to realize a printing table which provides printing solid model in 5 axes, reduces the production duration of the parts with complex curved surface geometries and an operation method thereof.

Another aim of the invention is to realize a printing table which increases the surface quality of the parts with complex curved surface geometries and an operation method thereof.

### BRIEF DESCRIPTION OF THE INVENTION

As defined in the first claim and the other dependent claims, in order to achieve the aim of this invention, the printing table consists of; lower table, support bracket, rotation shaft, connection bracket, horizontal rotation provider, threaded connection element, rotation gear, trigger gear and vertical rotation provider. The lower table is connected to the support bracket. The rotation shaft enables the lower table to rotate around the horizontal axis. The rotation gear enables the lower table to perform rotational movement around the vertical axis. In the operation method of the printing table, first of all the solid model of the part to be printed is converted into a computer model. Then, the parametric modeling of the linear projections of the part to be printed is carried out. The sag angle in the first printing direction and in the second printing direction is calculated. Then, the process step of determining the rotation angles of the horizontal axis and vertical axis is carried out. The computer model is rotated by using the rotation angles of the horizontal axis and the vertical axis. The process of creating the required slicing layers and layout path for printing by using the rotated computer model is performed. Process of the creation of the production code to move the lower table and the print head is realized. Finally the process of moving the lower table and the print head by means of the horizontal rotation provider and the vertical rotation provider with the created production code is realized.

### DETAILED DESCRIPTION OF THE INVENTION

The printing table and the operation method thereof realized to fulfill the aims of the present invention are illustrated in the accompanying figures, in which:

FIG. 1. is a perspective view of the printing table.

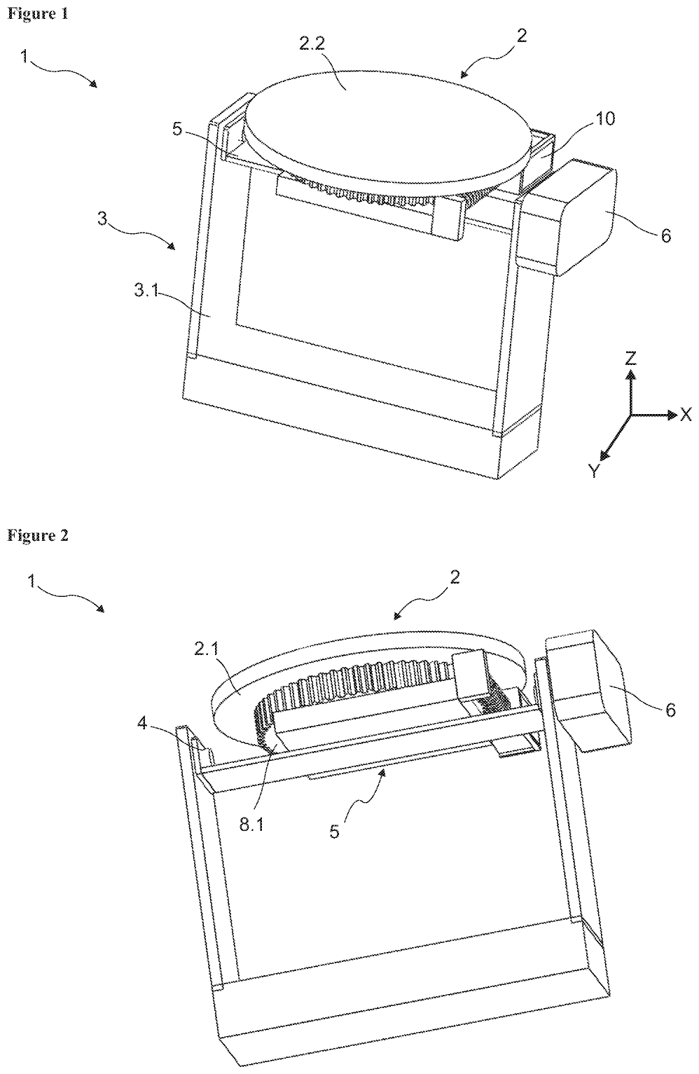

FIG. 2. is a perspective view of the printing table from another angle.

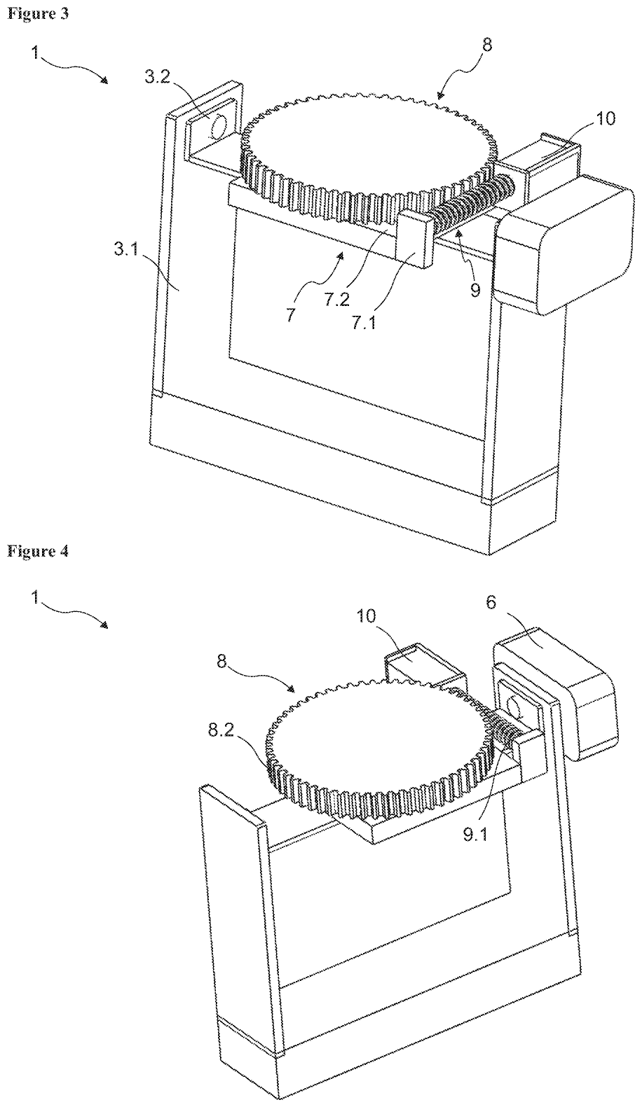

FIG. 3. is a perspective view of the printing table with the lower table removed.

FIG. 4. is a perspective view of the printing table with the lower table removed.

FIG. 5. is a schematic view of the first printing direction and the second printing direction on the parametric surface model.

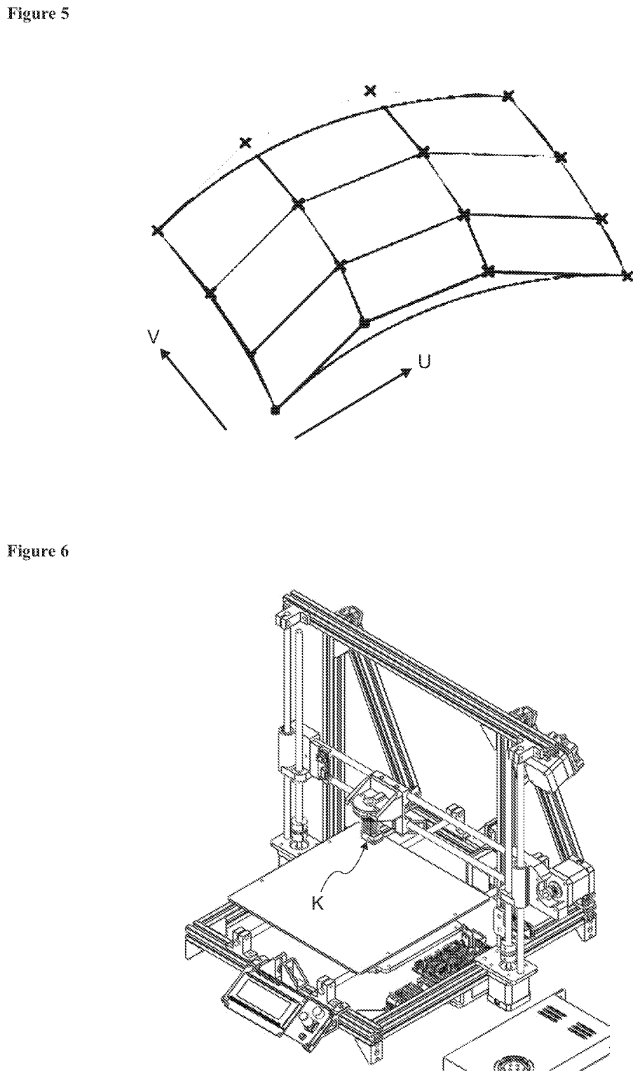

FIG. 6. is a perspective view of the print head on the three dimensional printer.

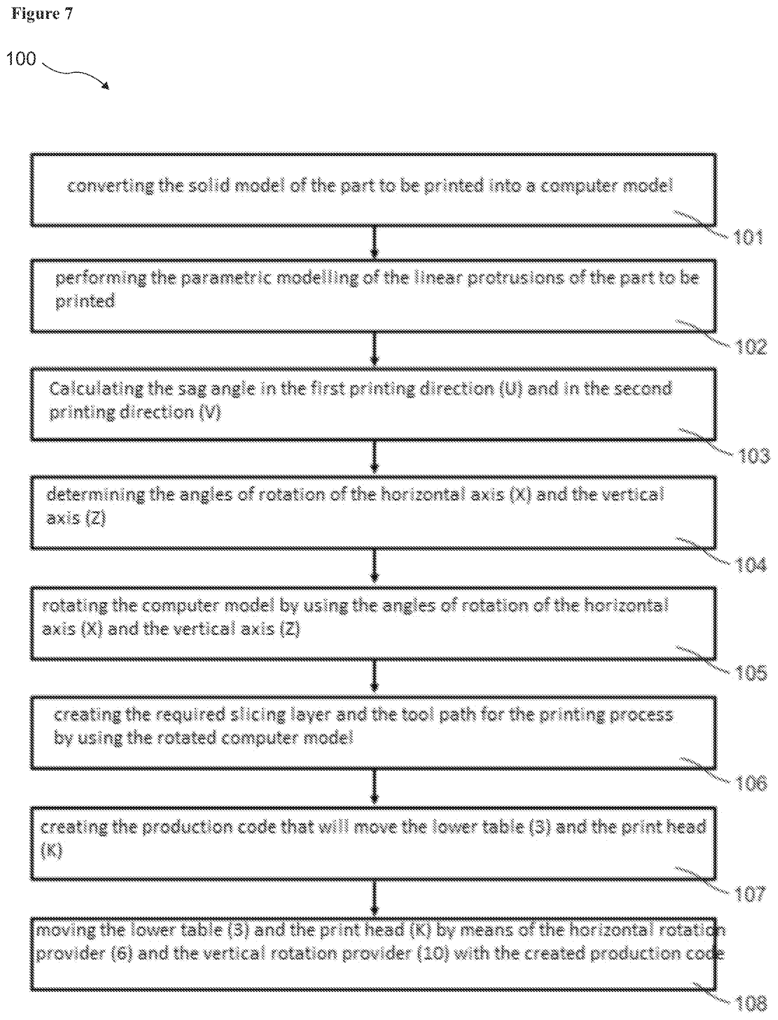

FIG. 7. is a schematic view of the flow chart of the operation method of the printing table.

The parts in the figure are enumerated one by one and the parts correspond to these numbers are given in the following:
1. Printing table
2. Lower table
   2.1. Bearing surface
   2.2. Printing surface
3. Support bracket
   3.1. Connection rod
   3.2. Bracket connection gap
4. Rotation shaft
5. Connection bracket
6. Horizontal rotation provider
7. Threaded connection element
   7.1. Connection surface
   7.2. Connection extension
8. Rotation gear
   8.1. Settlement surface
   8.2. Rotation gear
9. Trigger gear
   9.1. Trigger thread
10. Vertical rotation provider
K. Print head
X. Horizontal axis
Y. Perpendicular axis
Z. Vertical axis
U. First printing direction
V. Second printing direction
100. Operation method of the printing table

The printing table (1) which is used in the printers adapted to form a three-dimensional solid model and provides positioning the solid model to be created during its production mainly comprises the following,
at least one lower table (3) on which solid model is created by means of the print head (K),
   which performs a rotational movement around the horizontal axis (X) and the vertical axis (Z) while the solid model is being formed on the same such that the print head (K) and the solid model is parallel to each other,
   enables the solid model to be positioned on it during the production of the solid model to be created such that the print head (K) and the solid model is parallel to each other,
at least one rotation shaft (4) which is connected to the lower table (3), performs rotational movement about the horizontal axis (X) and enables the rotation of the lower table (3) about the horizontal axis (X),
at least one rotation provider (6) which is connected to the rotation shaft (4), provides the required force for the rotation of the rotation shaft (4) about the horizontal axis (X),
at least one rotation gear (8) on which the lower table (3) is located, which performs rotational movement about the vertical axis (Z) and enables the rotation of the lower table (3) about the vertical axis (Z),
at least one trigger gear (9) which is connected to the rotation gear (8), performs rotational movement around the central axis, enables the rotation gear (8) to rotate about the vertical axis (Z) with the rotational movement it performs about the central axis,
a vertical rotation provider (10) which is connected to the trigger gear (9), provides the required force for enabling the trigger gear (9) to rotate about the central axis.

The inventive printing table (1) is used in the printers which are adapted to create a three-dimensional solid model. The printing table (1) provides positioning the solid model to be created during its production. The three-dimensional printers in the state of the art perform linear positioning only on the horizontal axis (X), perpendicular axis (Y) and vertical axis (Z). The printing table (1) can perform rotational movement about the horizontal axis (X) and the vertical axis (Z) when the print head (K) moves along the horizontal axis (X), perpendicular (Y), vertical axis (Z) during the creation of the solid model in the three-dimensional printers. The movement process on 5 axes is realized while the solid model is created by means of the rotational movement of the printing table (1) about the horizontal axis (X) and vertical axis (Z). The printing table (1) comprises lower table (2), support bracket (3), rotation shaft (4), connection bracket (5), horizontal rotation provider (6), threaded connection element (7), rotation gear (8), trigger gear (9) and vertical rotation provider (10).

Solid model is created on the lower table (2) in one embodiment of the invention by means of the print head (K). The lower table (2) may be in a preferred geometric shape. In this embodiment of the invention, the lower table (2) has a circular geometric form. The lower table (2) can be produced in a geometric form that can be able rotate about the vertical axis (Z) at a preferred angle. The lower table (2) performs a rotational movement about the horizontal axis (X) and the vertical axis (Z) while the solid model is being formed on the same such that the print head (K) and the solid model are parallel to each other. The lower table (2) enables the solid model to be positioned on it during the production of the solid model to be created such that the print head (K) and the solid model is parallel to each other. The lower table (2) comprises bearing surface (2.1) and printing surface (2.2). The lower table (2) is located on the rotation gear (8) over the bearing surface (2.1). The lower table (2) can preferably move together with the rotation gear (8). The lower table (2) is connected with the rotation gear (8). The lower table (2) is connected to the rotation gear (8) from the bearing surface (2.1). The bearing surface (2.1) and the printing surface (2.2) are preferably parallel to each other. When the lower table (2) is connected to the rotation gear (8) through the bearing surface (2.1), the printing surface (2.2) is preferably positioned facing the print head (K). When the lower table (2) is placed, the solid model is printed on the printing surface (2.2) with the print head (K). The lower table (2) can always be positioned parallel to the print head (K) by means of the rotation gear (8). The parallel position of the lower table (2) to the print head (K) is provided by the movements of the rotation gear (8) and the connection bracket (5) about their central axes.

The support bracket (3) in one embodiment of the invention is adapted to support the lower table (2) to rotate about the horizontal axis (X) and the vertical axis (Z). In this embodiment of the invention, the support bracket (3) is preferably in U geometric form. The support bracket (3) provides the lower table (2) to be positioned at a preferred height from the floor such that its rotational movement about the horizontal axis (X) and the vertical axis (Z) is not prevented. Support bracket (3) comprises connection rod (3.1) and bracket connection gap (3.2). In this embodiment of the invention, the support bracket (3) has two connection arms (3.1) which are in U geometric form and are parallel to each other. There is a bracket connection gap (3.2) on the two connection arms (3.1). The bracket connection gap (3.2) provides the connection of the connection bracket (5) to the support bracket (3). The bracket connection gap (3.2) is preferably in a circular geometric form, and can be adjusted such that a rotation shaft (4) is fitted into it. The bracket connection gaps (3.2) are positioned on the connection arms (3.1) such that they are parallel to each other and are concentric.

The rotation shaft (4) in one embodiment of the invention is used to rotate the connection bracket (5) about the horizontal axis (X). The rotation shaft (4) is inserted to the bracket connection gap (3.2) in the support bracket (3). The diameter of the rotation shaft (8) is adjusted such that it performs its rotational movement about the central axis without being subject to friction within the bracket connection gap (3.2). The rotation shaft (4) connects the connection bracket (5) and the support bracket (3) to each other. The rotation shaft (4) is connected to the lower table (3). The rotation shaft (4) rotates about the horizontal axis (X). The rotation shaft (4) provides the lower table (3) to rotate about the horizontal axis (X). The rotation shaft (4) is used in rotating the connection bracket (5) about the horizontal axis (X) by connecting the connection bracket (5) and the support bracket (3) to each other.

The connection bracket (5) in one embodiment of the invention is connected to the rotation gear (8) and the support bracket (3). The connection bracket (5) connects to the support bracket (3) by means of the rotation shaft (4). Connection bracket (5) comprises shaft clearance (5.1). The connection bracket (5), the shaft clearance (5.1) and the bracket connection gap (3.2) are aligned on the support bracket (3) such that their central axes coincide. After the central axes of the shaft clearance (5.1) and the bracket connection gap (3.2) are aligned in a coincident manner then rotation shaft (4) is passed through. The rotation shaft (4) can rotate around the central axis within the shaft clearance (5.1) and the bracket connection gap (3.2).

The horizontal rotation provider (6) in one embodiment of the invention is in connected manner to the rotation shaft (4). The horizontal rotation provider (6) provides the required force for the rotation of the rotation shaft (4) around the horizontal axis (X). Preferably a motor can be used as the horizontal rotation provider (6). The horizontal rotation provider (6) provides the required force for the rotation of the rotation shaft (4) about its central axis. While the horizontal rotation shaft (6) and the rotation shaft (4) rotate about the central axis, the connection bracket (5) which is connected to the rotation shaft (4) can make a rotational movement at a preferred angle about the horizontal axis (X). The horizontal rotation provider (6) can be controlled by means of a preferred control system.

The threaded connection element (7) in one embodiment of the invention is used in the connection of the rotation gear (8) to the support bracket (3). The threaded connection element (7) may be in a preferred geometric shape. The rotation gear (8) is connected to the threaded connection element (7). The threaded connection element (7) is adapted in a geometric form which will not prevent the rotation of the rotation gear (8) about the horizontal axis (Z). The threaded connection element (7) is in a fixed position on the support bracket (3). The rotation gear (8) is connected to the threaded connection element (7) preferably by means of a shaft passing through its center and can perform rotational movement about said shaft. Threaded connection element (7) comprises connection surface (7.1) and connection extension (7.2). Rotation gear (8) is positioned with the threaded connection element (7) such that the connection surface (7.1) is in a parallel position. The connection extension (7.2) in the threaded connection element (7) forms a bearing to the trigger gear (9). The connection extension (7.2) is preferably located on the threaded connection element (7) and may be in a form integral with the threaded connection element (7) or independent from the threaded connection element (7). The connection extensions (7.2) are located parallel to each other in the threaded connection element (7) and the trigger gear (9) is placed between them.

The lower table (3) is located on the rotation gear (8) in one embodiment of the invention. The rotation gear (8) performs rotational movement about the vertical axis (Z). The rotation gear (8) enables the lower table (3) to rotate about the vertical axis (Z). The rotation gear (8) comprises settlement surface (8.1) and rotation thread (8.2). The rotation gear (8) is preferably in a circular geometric form and has more than one rotation threads (8.2) in its surrounding. The rotation gear (8) is positioned on the threaded connection element (7) such that it is parallel with the settlement surface (8.1) and the connection surface (7.1). The rotation gear (8) is connected to the threaded connection element (7). The rotation gear (8) is connected to the threaded connection element (7) preferably by means of a shaft passing through its center and can perform rotational movement about said shaft. The rotation gear (8) is positioned such that its rotation threads (8.2) stay in contact with the trigger gear (9). The lower table (2) can rotate about the vertical axis (Z) at preferred angles with the movement of the rotation gear (8) about the central axis.

The trigger gear (9) in one embodiment of the invention is found connected with the rotation gear (8). The trigger gear (9) performs rotational movement about the central axis. The trigger gear (9) enables the rotation gear (8) to rotate about the vertical axis (Z) with the rotational movement it performs about the central axis. Trigger gear (9) comprises trigger thread (9.1). The trigger gear (9) is preferably in cylindrical geometric form in this embodiment of the invention, there are helical trigger threads (9.1) on its cylindrical surface. The trigger gear (9) is located between the connection extensions (7.2) on the threaded connection element (7). The trigger gear (9) triggers the rotational movement of the rotation gear (8) about the central axis. The trigger gear (9), rotation gear (8) is located such that the trigger threads (9.1) are in contact with the rotation threads (8.2). While the trigger gear (9) makes rotational movement about the central axis, the helical formed openable trigger threads (9.1) are movable forward and backward on the perpendicular axis (Y) depending on the rotation of the trigger gear (9) about the central axis to the right or left. In case the trigger gear (9) rotates about the central axis in a preferred direction, the trigger threads (9.1) can move forward and backward on the perpendicular axis (Y). In case the trigger gear (9) rotates about the central axis in the opposite direction of the preferred direction, the trigger threads (9.1) can move backward on the perpendicular axis (Y). During the rotation movement of the trigger gear (9) about the central axis, the rotation gear (8) can perform rotational movement about the vertical axis (Z) by means of the rotation threads (8.2) that are in contact with the trigger gears (9.1). During the rotation movement of the trigger gear (9) about the central axis, the trigger threads (9.1) apply pressure to the rotation threads (8.2) to which they stay in contact and try to push the same in one direction. The rotation gear (8) makes rotational movement about the vertical axis (Z) with the effect of the compressive force applied by the trigger threads (9.1) on the rotation threads (8.2). In case the trigger gear (9) rotates about the central axis in a preferred direction, the trigger threads (9.1) can move forward and backward on the perpendicular axis (Y) and the rotation gear (8) can perform rotational movement about the vertical axis (Z) in one direction. In case the trigger gear (9) rotates about the central axis in an opposite direction of the preferred direction, the trigger threads (9.1) can move backward on the perpendicular axis (Y) and the rotation gear (8) can perform rotational movement about the vertical axis (Z) in the opposite direction. The rotational movement of the trigger gear (9) about the central axis is provided by the vertical rotation provider (10).

The vertical rotation provider (10) in one embodiment of the invention is found connected with the rotation gear (9). The vertical rotation provider (10) provides the required force for enabling the trigger gear (9) to rotate about the central axis. The vertical rotation provider (10) provides the required force for enabling the trigger gear (9) to rotate about the perpendicular axis (Y). Preferably a motor can be used as the vertical rotation provider (10). The vertical rotation provider (10) provides the required force for enabling the trigger gear (9) to rotate about the perpendicular axis (Y). While the vertical rotation shaft (10) and the trigger gear (9) rotate about the central axis or the perpendicular axis (Y), the rotation gear (8) which is connected to the trigger gear (9) can make a rotational movement with a preferred angle about the vertical axis (Z). The vertical rotation provider (10) can be controlled with a preferred control system similar to the horizontal rotation provider (6).

The use of the printing table (1) in this embodiment of the invention is realized by means of the operation method of the printing table (100).

The printing table operation method (100) which is used in the printers adapted to form a three-dimensional solid model and provides positioning the solid model to be created during its production mainly comprises the following process steps;
converting the solid model of the part to be printed into a computer model (101),
carrying out the parametric modeling of the linear projections of the part to be printed (102),
calculating the sag angle in the first printing direction (U) and in the second printing direction (V) (103),
determining rotation angles of the horizontal axis (X) and the vertical axis (Z) (104),
rotating the computer model by using the rotation angles of the horizontal axis (X) and the vertical axis (Z) (105),
creating the required slicing layers and layout path for printing by using the rotated computer model (106),
creating the production code to move the lower table (3) and the print head (K) (107),
moving the lower table (3) and the print head (K) by means of the horizontal rotation provider (6) and the vertical rotation provider (10) with the created production code (108).

The inventive operation method of the printing table (100) is used to position the printing table (1) by rotating the same about the horizontal axis (X) and the vertical axis (Z). The operation method of the printing table (100) is used to position the printing table (1) in the printers adapted for creating three-dimensional solid model by rotating the same about the horizontal axis (X) and the vertical axis (Z). The operation method of the printing table (100) provides positioning the printing table (1) during the production of the solid model to be created.

The solid model to be printed with the three-dimensional printer in this embodiment of the invention is converted into a computer model (101). Converting said solid model into a computer model can be realized with different programs. A computer model can be formed based on the program used during the conversion of the solid model to a computer model. The created computer model can be adjusted by preferably the three-dimensional drawing based on the computer program used. After the process of converting the solid model to be printed into a computer model (101), the process of carrying out the parametric modeling of the linear projections of the part to be printed (102) is initiated. The parametric modeling process with STL extension to be used in the three-dimensional printers is realized in this embodiment of the invention. Said parametric modeling process is the modeling process of the surfaces of the solid model converted into a computer model with preferably the triangular surface elements. In the process of carrying out the parametric modeling process with STL extension of the linear projections of the part to be printed (102), while STL parametric modeling is performed, the parametric modeling of the surface of the computer model is performed. The surface geometry of the three-dimensional computer model is illustrated by said parametric modeling. While the parametric modeling of the three-dimensional computer model is made, the surface geometry of the computer model is divided into triangles or combined as triangles.

In another embodiment of the invention, in the process of carrying out the parametric modeling process of the linear projections of the part (102), the parametric modeling with NURBS curve can be performed. In case parametric modeling is performed with NURBS curve, a point is determined on the surface of the three-dimensional model with the created parametric model. The angle of the point determined on the three-dimensional model is determined according to the model surface by NURBS curve in the process of carrying out the parametric modeling. In the process step of performing parametric modeling of the linear protrusions of the part (102), NURBS curve and the parametric modeling technique are used optionally.

In one embodiment of the invention, in the process of carrying out the parametric modeling process of the linear projections of the part to be printed (102), the parametric curve or parametric surface modeling can be performed. At the same time, in the process step of carrying out the parametric modeling of the linear protrusions of said part to be printed (102), parametric modeling can be performed by determining the parts with linear sagging surface and the parts with non-linear sagging surfaces. The process of carrying out the same parametric modeling for the parts with linear sagging surface and the parts with non-linear sagging surfaces is realized (102). In the process step of carrying out the parametric model of the linear projections of the part to be printed (102), the parametric curve modeling techniques are used in case there are linear sagging surfaces on the part. A preferred parametric curve modeling method can be used for the parts having linear sagging surfaces. The parametric modeling techniques such as NURBS, Bezier curves or B-spline can be used for the parts with linear sagging surfaces. In this embodiment of the invention, preferably NURBS parametric curve modeling technique is used for the parts with linear sagging surfaces. In the process step of carrying out the parametric model of the linear projections of the part to be printed (102), parametric surface modeling methods can be used in case there are non-linear sagging surfaces on the part. In this embodiment of the invention, in the non-linear parametric surface modeling, NURBS modeling technique can be used similar to the parametric curve modeling.

In one embodiment of the invention, in the process step of carrying out the parametric model of the linear projections of the part to be printed (102), modeling the linear and non-linear sagging surface with NURBS modeling method is realized. The planar slices are formed during printing process of the solid model such that said nonlinear sagging surfaces are perpendicular to the surface printing head or parallel to the horizontal plane according to the sag angle in each layer. In this case, said planar slices are determined according to the sag angle of nonlinear sagging surface.

In one embodiment of the invention, after the process step of carrying out the parametric modeling of the linear projections of the part to be printed (102), the process of calculating the sag angle in the first printing direction (U) and in the second printing direction (V) (103) is realized. After the parametric modeling is realized (102), there are two directions on the model as the first printing direction (U) and the second printing direction (V). The horizontal axis (X), perpendicular axis (Y) and vertical axis (Z) coordinates that correspond to the values of said first printing direction (U) and the second printing direction (V) can be obtained by assigning preferred values (between 0 and 1) to the first printing direction (U) and the second printing direction (V) on the parametric model. The non-linear surfaces on the parametric model can be determined and modeled depending on the obtained coordinates of the horizontal axis (X), perpendicular axis (Y) and the vertical axis (Z). After the parametric modeling is made (102), the angle between each values of the first printing direction (U) and second printing direction (V) on the model and the previous first printing direction (U) and the second printing direction (V) values are compared (103). In this embodiment of the invention, the limit sag angle of the sagging surface of the parametric model is determined by the user. After calculating the sag angle in the first printing direction (U) and in the second printing direction (V) (103), the calculated angles are compared with the limit sag angle determined by the user. The limit sag angle can be determined as 45° or 30°. In this embodiment of the invention, the 45° sag angle is determined as the upper limit. The sag angles in the first printing direction (U) that is greater in terms of limit sag angle and the sag angles in the second printing direction (V) are determined by comparing the calculated sag angles in the first printing direction (U) and in the second printing direction (V). When the sag angles in the first printing direction (U) that is greater in terms of limit sag angle and the sag angles in the second printing direction (V) are determined, flows occur during the model creation.

In one embodiment of the invention, the process step of calculating the sag angle in the first printing direction (U) and in the second printing direction (V) (103), the determination of the angles of rotation of the horizontal axis (X) and the vertical axis (Z) is made (104). In the process step of calculating the sag angle in the first printing direction (U) and in the second printing direction (V) (103), the determination of the sag angles in the first printing direction (U) that is greater in terms of limit sag angle and the sag angles in the second printing direction (V) and the angles of rotation of the horizontal axis (X) and the vertical axis (Z) is made (104).

In one embodiment of the invention, after the process step of determining the angles of rotation of the horizontal axis (X) and the vertical axis (Z) (104), the process step of rotating the computer model by using the rotation angles of the horizontal axis (X) and the vertical axis (Z) (105) is realized. Software matrix is created from the angles of rotation of the horizontal axis (X) and the vertical axis (Z) determined depending on the geometry of the created computer model. The computer model is rotated by using the rotation angles of the horizontal axis (X) and the vertical axis (Z) depending on the created matrix (105).

In one embodiment of the invention, after the process step of rotating the computer model by using the rotation angles of the horizontal axis (X) and the vertical axis (Z) (105), the process step of creating the required slicing layers and tool path for printing by using the rotated computer model (106) is realized. The slicing layers and the tool path are determined according to the path to be followed based on the angles of rotation of the horizontal axis (X) and the vertical axis (Z) determined during the printing process of the computer model. In this embodiment of the invention, the G code that contains the tool path is created. Said G code is the code which consists of the horizontal axis (X), perpendicular axis (Y), vertical axis (Z), angle of rotation on the horizontal axis (X) and the angle of rotation on the vertical axis (Z), gives the path of the print head (K) that it will follow during printing process of the computer model.

After the process of creating the required slicing layers and tool path for printing by using the rotated computer model (106), the production code which will move the lower table (3) and the print head (K) is created (107) in one embodiment of the invention. Said G code can be used as the production code.

In one embodiment of the invention, after the production code which will move the lower table (3) and the print head (K) is created (107), the process of moving the lower table (3) and the print head (K) by means of the horizontal rotation provider (6) and the vertical rotation provider (10) with the created production code (108) is realized. In the process step of moving the lower table (3) and the print head (K) by means of the horizontal rotation provider (6) and the vertical rotation provider (10) with the created production code (108), said production code is transmitted to the horizontal rotation provider (6) and the vertical rotation provider (10). After the transmission of the production code to the horizontal rotation provider (6) and the vertical rotation provider (10), the linear motion of the print head (K) on the horizontal axis (X), perpendicular axis (Y) and vertical axis (Z), the rotational movement of the lower table (3) about the horizontal axis (X) and the vertical axis (Z) are provided based on the determined sag angles. In this case, the surface formation quality can be increased and the production period can be reduced during the production of the parts with non-linear or linear sagging surfaces with the printing table and the operation method (100) thereof.

1. A printing table which is used in printers adapted to form a three-dimensional solid model and provides positioning of the solid model to be created during its production, the printing table comprising:
at least one lower table on which the solid model is created by means of a print head;
the at least one lower table adapted to perform a rotational movement about a horizontal axis (X) and the a vertical axis (Z) while the solid model is being formed such that the print head and the solid model are parallel to each other;
the at least one lower table enables the solid model to be positioned on it during the production of the solid model to be created such that the print head and the solid model are parallel to each other;
at least one rotation shaft which is connected to the lower table, the at least one rotation shaft performs rotational movement around the horizontal axis (X) and enables the rotation of the lower table about the horizontal axis (X);
at least one rotation provider which is connected to the rotation shaft, the at least one rotation provided providing required force for the rotation of the rotation shaft about the horizontal axis;
at least one rotation gear on which the lower table is located, which performs rotational movement about the vertical axis (Z) and enables the rotation of the lower table about the vertical axis;
at least one trigger gear which is connected to the rotation gear, the at least one trigger gear performs rotational movement about the central axis, enables the rotation gear to rotate about the vertical axis (Z) with the rotational movement it performs about the central axis; and
a vertical rotation provider which is connected to the trigger gear, the vertical rotation provided provides the required force for enabling the trigger gear to rotate about the central axis.

2. The printing table of claim 1, wherein the lower table comprises a bearing surface and a printing surface, and is fitted on the rotation gear through the bearing surface and can move together with the rotation gear.

3. The printing table of claim 1, wherein the lower table comprises a printing surface and a bearing surface that are parallel to each other, and in which the printing surface is in a position preferably facing the print head when it is connected to the rotation gear over the bearing surface.

4. The printing table of claim 1, wherein the lower table whose being parallel to the print head is provided by the movements of the rotation gear and a connection bracket about their central axes.

5. The printing table of claim 1, wherein the rotation shaft which connects a connection bracket and the support bracket to each other, is used in rotating the connection bracket about the horizontal axis.

6. The printing table of claim 1, wherein a connection bracket which comprises a shaft clearance, connects to the rotation gear and the support bracket, is aligned on the support bracket such that the central axes of the shaft clearance and the bracket connection gap are coincident and performs rotational movement about the central axis within the shaft clearance and the bracket connection gap.

7. The printing table of claim 1, wherein the rotation gear comprises a settlement surface and rotation thread, and is positioned on the threaded connection element such that it is parallel with the settlement surface and a connection surface, enables the lower table to rotate about the vertical axis (Z).

8. The printing table of claim 1, wherein the trigger gear comprises a trigger thread, and is located such that the rotation gear and the trigger threads are in contact with the rotation threads, triggers the rotational movement of the rotation gear about the central axis.

9. The printing table of claim 1, wherein the trigger gear, which is in a forward and backward movable position on the perpendicular axis (Y) depending on the rotation of helical formed openable trigger threads, trigger gear about the central axis to the right and left while it makes rotational movement about its central axis.

10. The printing table of claim 1, wherein the trigger gear comprises trigger threads that can move forwardly on the perpendicular axis (Y) in case it rotates about its central axis in a preferred direction.

11. The printing table of claim 1, wherein the trigger gear comprises trigger threads that can move backwardly on the perpendicular axis (Y) in case it rotates in the opposite direction of the preferred direction around its central axis.

12. The printing table of claim 1, wherein the trigger gear which enables the rotation gear to perform rotational movement about the vertical axis (Z) by means of rotation threads of the rotation gear during contact with trigger threads of the trigger gear while it performs rotational movement about its central axis.

13. The printing table of claim 1, wherein the trigger gear tries to push rotation threads of the rotation gear that trigger threads of the trigger gear are in contact with during its rotational movement about the central axis by applying pressure to the same.

14. The printing table of claim 1, wherein the trigger gear enables the rotation gear to perform rotational movement about the vertical axis (Z) with compressive force that it applies to rotation threads of the rotation gear.

15. The printing table of claim 1, wherein in case trigger threads of the trigger gear rotate around the central axis in a preferred direction, the trigger gear can move forward on the perpendicular axis (Y) and enables the rotation gear to perform rotational movement about the vertical axis (Z) in one direction.

16. The printing table of claim 1, wherein in case trigger threads of the trigger gear rotate about the central axis in a preferred direction, the trigger gear can move backward on the perpendicular axis (Y) and enables the rotation gear to perform rotational movement about the vertical axis (Z) in the opposite direction.

17. Operation method of a printing table which is used in printers adapted to form a three-dimensional solid model and provides positioning the solid model to be created during its production is mainly, characterized by the following process steps:
converting the solid model of the part to be printed into a computer model (101),
carrying out parametric modeling of linear projections of the part to be printed (102),
calculating a sag angle in a first printing direction (U) and in a second printing direction (V) (103),
determining rotation angles of a horizontal axis (X) and a vertical axis (Z) (104),
rotating the computer model by using the rotation angles of the horizontal axis (X) and the vertical axis (Z) (105),
creating required slicing layers and a layout path for printing by using the rotated computer model (106),
creating production code to move a lower table and a print head (107), and
moving the lower table and the print head by means of a horizontal rotation provider and a vertical rotation provider with the created production code (108).

18. Operation method of a printing table according to claim 17, wherein in the process of carrying out the parametric modeling of the linear protrusions of the part to be printed, performing parametric modeling process with an STL extension.

19. Operation method of a printing table according to claim 17, comprising parametric modeling with NURBS curve, determining a point on the surface of the three-dimensional model with the created parametric model and determining an angle of a determined point according to the model surface by NURBS curve in the process step of carrying out the parametric modeling of the linear projections of the part to be printed (102).

20. Operation method of a printing table according to claim 17, comprising carrying out the parametric modeling by determining parts with linear sagging surfaces and parts with nonlinear sagging parts in the process step of carrying out the parametric model of the linear projections of the part to be printed (102).

21. Operation method of a printing table according to claim 17, comprising using the parametric curve modeling techniques in case there are linear sagging surfaces on the part in the process step of carrying out the parametric model of the linear projections of the part to be printed (102).

22. Operation method of a printing table according to claim 17, comprising using the parametric curve modeling techniques in case there are non-linear sagging surfaces on the part in the process step of carrying out the parametric model of the linear projections of the part to be printed (102).

23. Operation method of a printing table according to claim 17, comprising modeling linear and non-linear sagging surface with NURBS modeling method in the process step of carrying out the parametric model of the linear projections of the part to be printed (102).

24. Operation method of a printing table according to claim 17, wherein in the process step of calculating sag angles in the first printing direction (U) and in the second printing direction (V) (103), obtaining the horizontal axis (X), perpendicular axis (Y) and vertical axis (Z) coordinates that correspond to the values of said first printing direction (U) and the second printing direction (V) by giving preferred values (between 0 and 1) to the first printing direction (U) and the second printing direction (V) on the parametric model.

25. Operation method of a printing table according to claim 17, wherein in the process step of calculating the sag angles in the first printing direction (U) and in the second printing direction (V)(103), determining and modeling the non-linear surfaces on the parametric model depending on the obtained coordinates of the horizontal axis (X), perpendicular axis (Y) and the vertical axis (Z).

26. Operation method of a printing table according to claim 25, wherein in the process step of calculating the sag angles in the first printing direction (U) and in the second printing direction (V) (103), comparing the calculated angles with the limit sag angle determined by the user.
Operation method of a printing table according to claim 26, wherein in the process step of calculating the sag angles in the first printing direction (U) and in the second printing direction (V)(103), determination of the sag angles in the first printing direction (U) that is greater in terms of limit sag angle and the sag angles in the second printing direction (V) by comparing the calculated sag angles in the first printing direction (U) and in the second printing direction (V).

28. Operation method of a printing table according to claim 17, wherein in the process step of determining the angles of rotation of the horizontal axis (X) and the vertical axis (Z) (104), determining the sag angles in the first printing direction (U) that is greater in terms of limit sag angle and the sag angles in the second printing direction (V) and the angles of rotation of the horizontal axis (X) and the vertical axis (Z).

29. Operation method of a printing table according to claim 17, wherein in the process step of rotating the computer model by using the rotation angles of the horizontal axis (X) and the vertical axis (Z)(105), creating a software matrix from the angles of rotation of the horizontal axis (X) and the vertical axis (Z) determined depending on the geometry of the created computer model.

30. Operation method of a printing table according to claim 17, wherein in the process step of creating the required slicing layers and tool path for printing by using the rotated computer model (106), determining the slicing layers and the tool path according to the path to be followed based on the angles of rotation of the horizontal axis (X) and the vertical axis (Z) determined during the printing process of the computer model.

31. Operation method of a printing table according to claim 17, wherein in the process step of moving the lower table and the print head by means of the horizontal rotation provider and the vertical rotation provider with the created production code (108), transmitting the production code to the horizontal rotation provider and the vertical rotation provider.

32. Operation method of a printing table according to claim 31, wherein in the process step of moving the lower table and the print head by means of the horizontal rotation provider and the vertical rotation provider with the created production code (108), providing the linear motion of the print head on the horizontal axis (X), perpendicular axis (Y) and vertical axis (Z), the rotational movement of the lower table about the horizontal axis (X) and the vertical axis (Z) based on the determined sag angles.
